(19) United States
(12) Patent Application Publication
(10) Pub. No.: US 2023/0184035 A1
(43) Pub. Date: Jun. 15, 2023

(54) Storage Rack Post Step and Assembly

(71) Applicant: JD Engineered Products LLC, Pleasant Lake, IN (US)

(72) Inventors: Jay Wetzel, Pleasant Lake, IN (US); Derek Wetzel, Pleasant Lake, IN (US)

(73) Assignee: JD Engineered Products LLC, Pleasant Lake, IN (US)

(21) Appl. No.: 17/549,366

(22) Filed: Dec. 13, 2021

(51) Int. Cl. E06C 9/04; A47B 97/00; E06C 7/08

(52) U.S. Cl. CPC E06C 9/04; A47B 97/00; E06C 7/08; A47B 2220/05

(57) ABSTRACT

A storage rack post step for use with a storage rack post, the storage rack post comprising a plurality of storage rack post holes, includes a body. The body has a step surface, a support surface configured to abut the storage rack post, a locating boss extending from the support surface and configured to be received by a storage rack post hole, and a bore extending through the support surface and the locating boss. The storage rack post step also includes a fastener configured to extend through the plurality of storage rack post holes and the bore and clampingly secure the storage rack post step to the storage rack post.

### BACKGROUND OF THE INVENTION

### 1. Field of the Invention

The present invention relates to devices which allow the user to retrieve items from the shelf of a storage rack. More particularly, the present invention relates to a device which can be easily secured to a storage rack post to provide a convenient standing platform and allow the user to retrieve items from higher shelves.

### 2. Background

Storage racks are commonly used in warehouses to store pallets, containers, and individual products. As such, it is often desirable for a worker to be able to climb a portion of the storage rack to access or remove products or containers stored thereon.

A storage rack is typically constructed of two or more vertical support elements and one or more horizontal support elements which form shelves. The shelves support pallets, containers, and products. The vertical support elements typically are constructed of metal and generally include a plurality of regularly spaced holes which can be used to mount the horizontal supports with bolts or other fasteners. Examples of such storage racks can be found in U.S. Pat. Nos. 3,303,937; 4,113,110; 4,549,665; 5,463,966: and 5,713,476. The plurality of regularly spaced holes allow adjustment of the shelves and fasteners.

Currently, when an item is located on a shelf out of reach, a worker must stand on a ladder, container, or the lower most shelf to reach up and attempt to grab the intended item. This can result in damage to the item or injury to the worker if the worker accidentally topples the item or the container onto themselves or if the worker slips from the ladder, container, or shelf they are standing on.

Accordingly, a need exists for a step device which can easily attach to the storage rack and allow a worker to safely climb a portion of the rack to access items stored thereon.

### SUMMARY OF THE INVENTION

In one form thereof, the present invention is directed to a step which can be attached to a storage rack post and provides a convenient means for climbing a portion of the storage rack post. The storage rack post comprises a body having a plurality of regularly spaced storage rack post holes extending clear through the body. The step includes a body having a step surface, a support surface configured to abut the storage rack post, and one or more locating bosses extending from the support surface and configured for insertion into one or more of the plurality of storage rack post holes. The cylindrical cavity formed by the locating boss defines a bore which extends clear through the support surface. One or more fasteners are configured to extend through one or more of the storage rack post holes and the bores to clampingly secure the step to the storage rack post.

Preferably, the locating boss can be inserted into one of the storage rack post holes, a fastener extended through the storage rack post hole and the locating boss, and the step can be clampingly secured to the storage rack post by the fastener such that the locating boss supports a portion of the shear stress experienced by the fastener during loading.

The step may optionally include one or more gussets which are configured to support the step surface in a position. Preferably, the step surface is supported in a horizontal position to form a stable platform for the worker to stand on.

Yet more preferably, two gussets are used wherein the gussets have a triangular shape and are disposed at the edges of the support surface and the step surface to form a box-like structure. The gussets may also be other shapes and in other arrangements relative to the support surface and the step surface.

Preferably, the fastener includes T-nuts disposed within the locating bosses and bolts having a threaded shank and a head, wherein the T-nuts are configured to threadingly engage the bolts. The T-nuts have an internally threaded barrel and a flange disposed at one end of the internally threaded barrel which is configured to apply a clamping force to the body when the bolt engages the T-nut. The T-nut may optionally include prongs or teeth protruding from the flange which embed in the body to prevent rotation of the T-nut within the locating boss.

Preferably, the locating bosses further comprise an annular lip disposed at the terminal end of the locating bosses and extending radially into the bores wherein the terminal ends of the internally threaded barrels opposite the flanges are configured to abut a surface of the annular lips. The annular lips are configured such that a threaded shank of the bolt extends radially to an inner cylindrical surface of the annular lips.

Preferably, when a bolt is extended through a storage rack post hole, a locking washer is disposed between the head of the bolt and the storage rack post to provide a greater contact area between the fastener and the storage rack post for clampingly securing the step to the storage rack post.

Preferably, the step surface is a tread and is textured to increase the worker’s grip while standing on the step. The pattern of texturing can be selected from a variety of options including, but not limited to, diamond plating, knurling, bar grating, cross-hatching, ribbing, granulating, and checkering.

The step can be manufactured from a variety of materials including, but not limited to, plastic, high density polyethylene (HDPE), and various types of metal. The step can also be manufactured by a variety of processes including, but not limited to, injection molding, machining, and additive manufacturing. The T-nuts can be embedded in the bores by either pressing the T-nuts into the holes after the step body is manufactured, or by manufacturing the step body around the T-nuts such as by injection molding the body around the T-nuts.

### BRIEF DESCRIPTION OF THE DRAWINGS

The above mentioned and other features of this invention, and the manner of attaining them, will become more apparent and the invention itself will be better understood by reference to the following description of the embodiments of the invention taken in conjunction with the accompanying drawings, wherein:

FIG. 1 is a perspective view of a storage rack post step attached to a storage rack post in accordance with the principles of the present invention in an oblique view from above;

FIG. 2 is an elevation side view of the device as shown in FIG. 1;

FIG. 3 is a cross-sectional view of the device as shown in FIG. 1;

FIG. 4 is an elevation front view of the storage rack post step in accordance with the principles of the present invention;

FIG. 5 is an elevation rear view of the device as shown in FIG. 4;

FIG. 6 is a first perspective view of the device as shown in FIG. 4 in an oblique view from behind;

FIG. 7 is a second perspective view of the device as shown in FIG. 4 in an oblique view from below;

FIG. 8 is an exploded perspective view of the device as shown in FIG. 1 in an oblique view from below.

Corresponding reference characters indicate corresponding parts throughout several views. Although the exemplification set out herein illustrates one embodiment of the invention, the embodiment disclosed below is not intended to be exhaustive or to be construed as limiting the scope of the invention to the precise form disclosed.

### DETAILED DESCRIPTION OF THE PREFERRED EMBODIMENTS

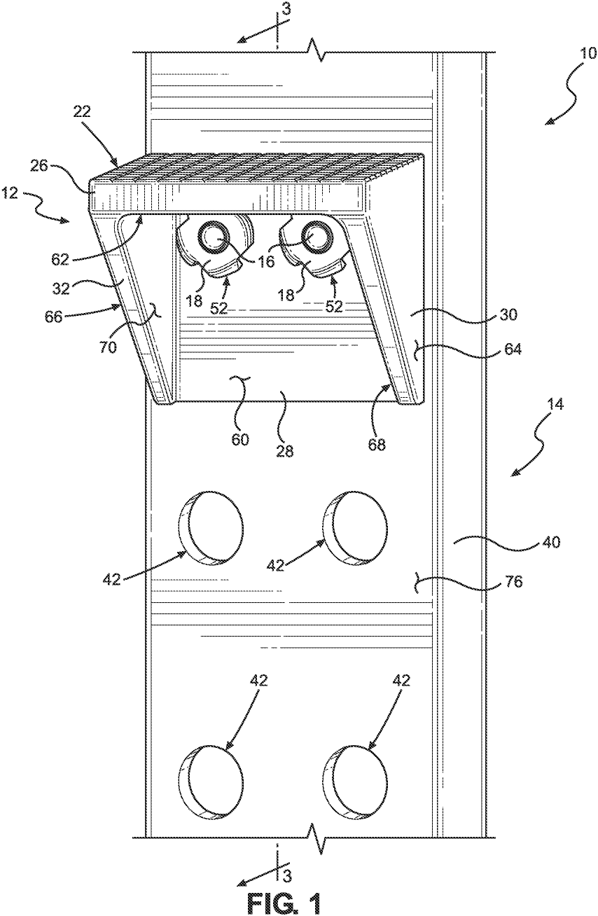

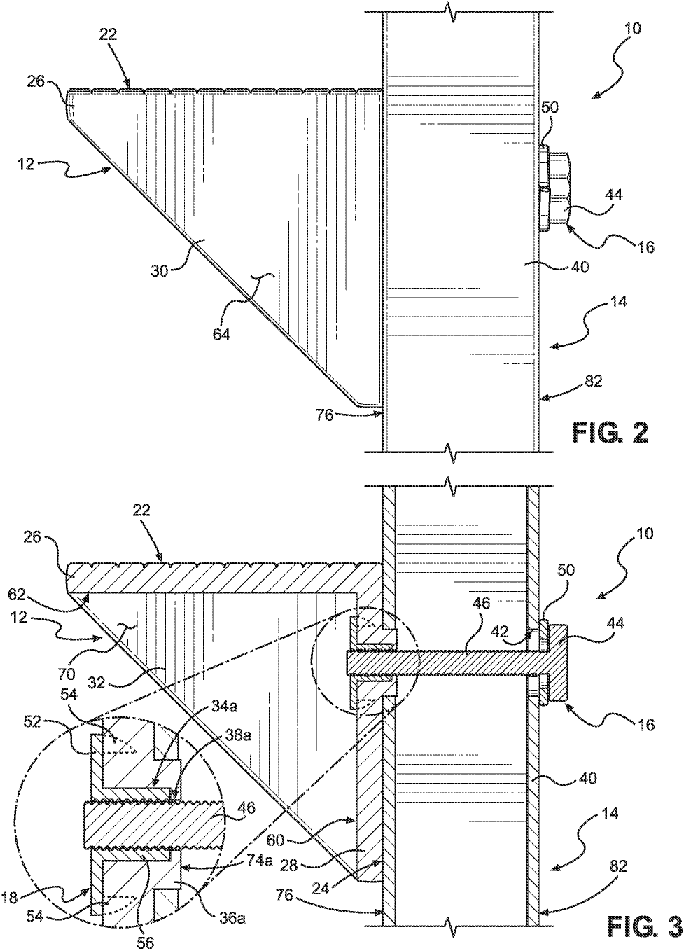

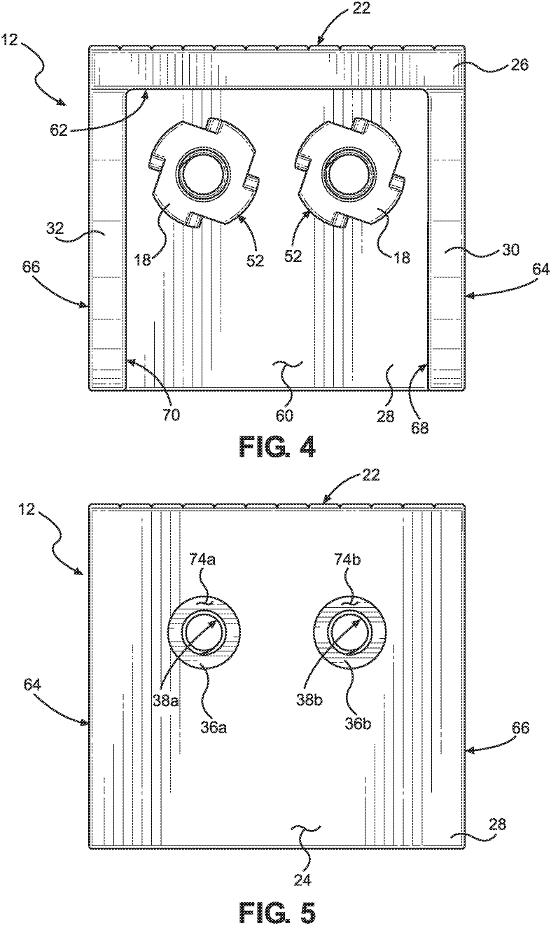

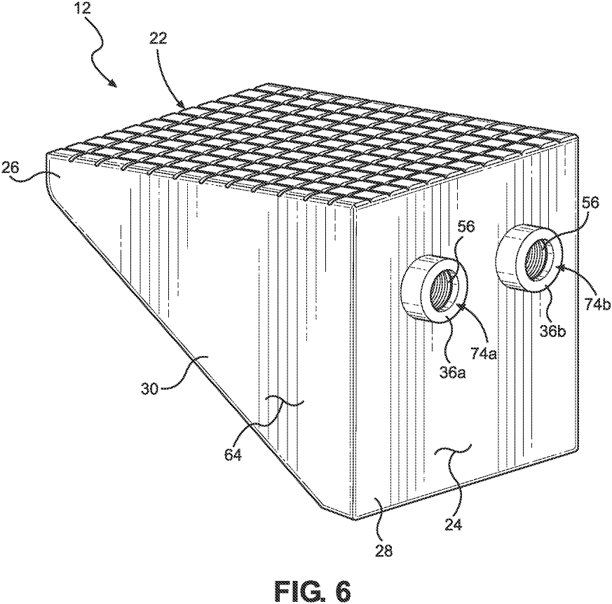

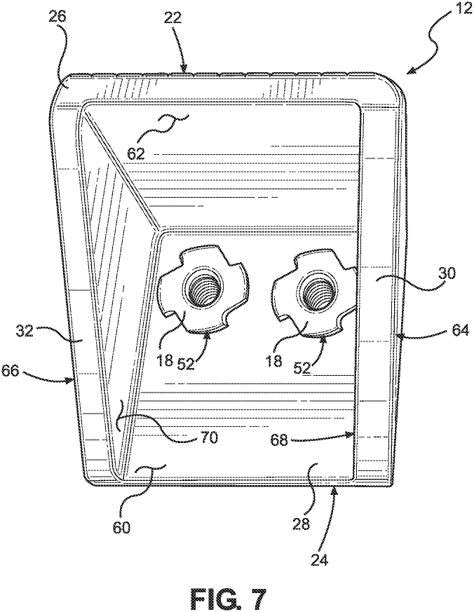

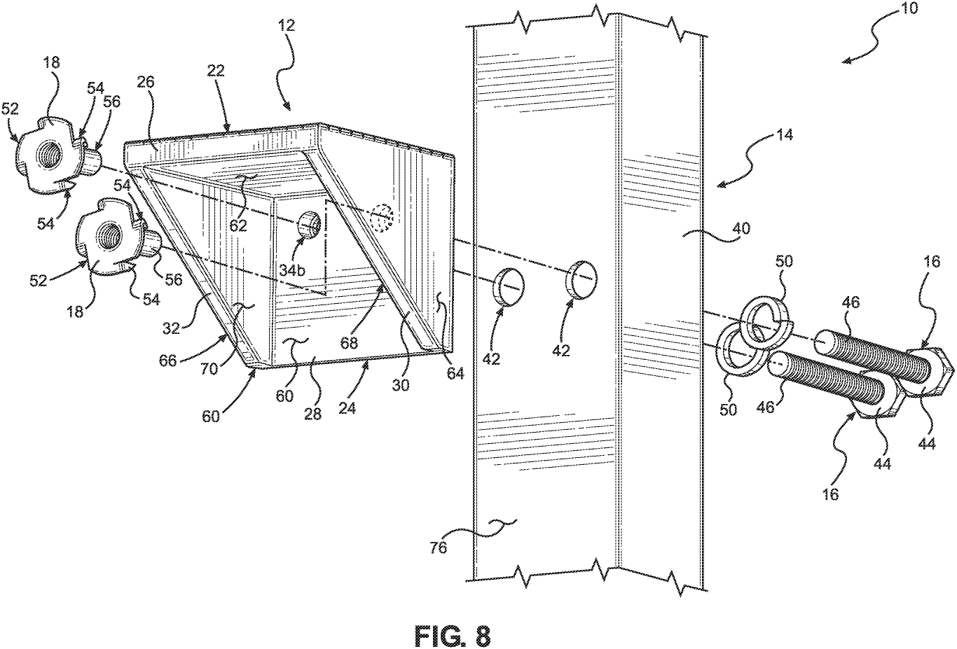

The storage rack post step assembly 10 shown in FIG. 1 comprises, in the present exemplary embodiment, a storage rack post step 12 secured to a storage rack post 14 with fasteners 16. The fasteners 16 each comprise a bolt 16 and a t-nut 18. The bolts 16 have a hexagonal head 44 and a threaded shank 46. The t-nuts 18 have a flange 52 and an internally threaded barrel 56. A plurality of prongs or teeth 54 extend from the flange 52 along and generally parallel to the barrel 56. Preferably, fasteners 16 further comprise locking washers 50 configured to abut a surface of hexagonal heads 44 adjacent threaded shanks 46 and fit circumferentially about threaded shanks 46.

The storage rack post step 12 can include a support wall 28 defined between a support surface 24 and a rear surface 60 and a platform 26 defined between a step surface 22 and a bottom surface 62. The support wall 28 and the platform 26 extend generally perpendicular to one another and are joined along a respective edge thereof for thereby forming an L-shape as best seen in FIG. 3. One or more gussets or gusset walls can be provided between the platform 26 and the support wall 28 for strengthening the step 12 and maintaining the platform 26 and the support wall 28 in their L-shape. Preferably, as best seen in FIG. 4, a left gusset wall 32 defined between a left exterior surface 66 and a left interior surface 70 is provided along a left edge of the platform 26 and the support wall 28, and a right gusset wall 30 defined between a right exterior surface 64 and a right interior surface 68 is provided along a right edge of the platform 26 and the support wall 28. The left and right gusset walls 30, 32 are preferably triangular shaped as shown in the drawings. As should now be appreciated, a pocket is formed between the platform 26, the support wall 28 and the left and right gusset walls 30, 32.

Locating bosses 36a 36b are integrally formed with or are otherwise secured to the support wall 28 and extend out and generally perpendicular from the support surface 24 to locating boss terminal ends 74a 74b. As best seen in FIG. 3, the locating bosses 36a 36b are shaped and sized to snugly fit within respective/adjacent storage rack post holes 42 when the post step 12 is placed against/abutting the storage rack post 14 with the support wall surface 24 against/abutting the storage rack post front surface 76. A bore 34a is provided through the support wall 28 and the locating boss 36a and extends from the support wall rear surface 60 to the locating boss terminal end 74a. A bore 34b is provided through the support wall 28 and the locating boss 36b and extends from the support wall rear surface 60 to the locating boss terminal end 74b. Bores 34a, 34b are sized and shaped to receive the threaded barrel 56 of a t-nut 18. Preferably, locating bosses 36a 36b further comprise annular flanges 38a 38b extending radially into bores 34a 34b from an inner surface of locating bosses 36a 36b adjacent locating boss terminal ends 74a 74b.

Preferably, platform 26 is a step tread wherein step surface 22 can have a texture configured to increase friction along step surface 22. The type of tread of platform 22 can include, but is not limited to, diamond plate tread, knurled tread, bar grated tread, cross-hatched tread, ribbed tread, and granulated tread.

The storage rack post step 12 is preferably made by injection molding or otherwise molding, forming or shaping from unitary material whereby the support wall 28, platform 26, left and right gusset walls 32, 30 and locating bosses 36a 36b are all integrally formed. Most preferably, the storage rack post step 12 is made by injection molding materials such plastic and high density polyethylene (HDPE).

Preferably, t-nuts 18 can be inserted or press fit into storage rack post step 12 such that threaded barrels 56 are inserted into bores 34a 34b, flanges 52 abut rear surface 60 and teeth 54 penetrate rear surface 60 and embed in support wall 28. Alternatively, storage rack post step 12 can be manufactured around t-nuts 18, for example, by injection molding storage rack post step 12 around t-nuts 18 such that bores 34a 34b are formed around threaded barrels 56, flanges 52 abut rear surface 60, and teeth 54 are embedded in support wall 28.

The storage rack post 14 can be a vertical post having a flat storage rack post front surface 76 and a flat storage rack post back surface 82 defining a storage rack post body 40 therebetween. A plurality of regularly spaced storage rack post holes 42 are provided through storage rack post body 40 and extend from storage rack post front surface 76 to storage rack post back surface 82.

The storage rack post step assembly 10 is used by holding storage rack post step 12 at a desired height and placing storage rack post step 12 against storage rack post 14 such that support surface 24 is against/abutting storage rack post front surface 76 and locating bosses 36a 36b are snugly fit within two storage rack post holes 42. Bolts 16 are extended through locking washers 50 until locking washers 50 abut hexagonal heads 44. Bolts 16 are then extended through storage rack post holes 42, beginning from storage rack post back surface 82, and through bores 34a 34b until threaded shanks 46 threadingly engage internally threaded barrels 56. Threaded shanks 46 are then rotatably threaded into internally threaded barrels 56 until locking washers 50 contact storage rack post back surface 82. Bolts 16 are then rotatably tightened until fasteners 16 clampingly secure storage rack post step 12 to storage rack post 14.

While the invention has been described as having an exemplary design, it can be further modified within the spirit and scope of this disclosure. This application is therefore intended to cover any variations, uses, or adaptations of the invention using its general principles.

What is claimed is:

1. A storage rack post step for use with a storage rack post comprising a plurality of storage rack post holes, the storage rack post step comprising:
a body having a step surface and a support surface, wherein the step surface extends at an angle relative to the support surface and the support surface is configured to abut the storage rack post;
a first locating boss extending from the support surface configured to be received within a first storage rack post hole;
a first bore extending through the support surface and the first locating boss; and,
a first fastener configured to extend through the first storage rack post hole and the first bore and clampingly secure the storage rack post step to the storage rack post with the support surface abutting the storage rack post.

2. The storage rack post step of claim 1 wherein the step surface extends at angle which is generally perpendicular relative to the support surface.

3. The storage rack post step of claim 1 further comprising a gusset wall between the step surface and the support surface.

4. The storage rack post step of claim 1 wherein the step surface is located on a step platform, the support surface is located on a support wall, a gusset wall extends between the step platform and the support wall, and further wherein the step platform, support wall and gusset wall are integrally formed together.

5. The storage rack post step of claim 1 wherein:
the first fastener comprises:
a bolt having a head and a threaded shank; and,
a T-nut having a flange and an internally threaded barrel;
wherein the bolt threaded shank is adapted to be threadingly received in the T-nut internally threaded barrel;
the support surface is located on a support wall defined between the support surface and a rear surface and the first bore extends through the support wall and the first boss from the support wall rear surface to a terminal end of the first boss; and,
the first fastener T-nut barrel is received in the first bore with its flange abutting the rear surface of the support wall.

6. The storage rack post step of claim 5 wherein the fastener T-nut further comprises a plurality of prongs extending into the support wall.

7. The storage rack post step of claim 5 wherein the first fastener further comprises a lock washer.

8. The storage rack post step of claim 1 further comprising:
a second locating boss extending from the support surface configured to be received within a second storage rack post hole;
a second bore extending through the support surface and the second locating boss; and,
a second fastener configured to extend through the second storage rack post hole and the second bore, whereby both the first and second fasteners clampingly secure the storage rack post step to the storage rack post with the support surface abutting the storage rack post.

9. The storage rack post step of claim 8 wherein:
the first and second fasteners each comprise:
a bolt having a head and a threaded shank; and,
a T-nut having a flange and an internally threaded barrel;
wherein the bolt threaded shank is adapted to be threadingly received in the T-nut internally threaded barrel;
the support surface is located on a support wall defined between the support surface and a rear surface;
the first bore extends through the support wall and the first boss from the support wall rear surface to a terminal end of the first boss;
the first fastener T-nut barrel is received in the first bore with its flange abutting the rear surface of the support wall;
the second bore extends through the support wall and the second boss from the support wall rear surface to a terminal end of the second boss; and,
the second fastener T-nut barrel is received in the second bore with its flange abutting the rear surface of the support wall.

10. The storage rack post step of claim 9 wherein the first and second fastener T-nuts each further comprise a plurality of prongs extending into the support wall.

11. A storage rack post and step assembly comprising:
a storage rack post comprising a plurality of storage rack post holes;
a storage rack post step comprising a body having a step surface and a support surface, wherein the step surface extends at an angle relative to the support surface and the support surface abuts the storage rack post;
a first locating boss extending from the support surface and received within a first storage rack post hole;
a first bore extending through the support surface and the first locating boss; and,
a first fastener extending through the first storage rack post hole and the first bore and clampingly securing the storage rack post step to the storage rack post with the support surface abutting the storage rack post and the first locating boss within the first storage rack hole.

12. The storage rack post and step assembly of claim 11 wherein the step surface extends at an angle which is generally perpendicular relative to the support surface.

13. The storage rack post and step assembly of claim 11 further comprising a gusset wall between the step surface and the support surface.

14. The storage rack post and step assembly of claim 11 wherein the step surface is located on a step platform, the support surface is located on a support wall, a gusset wall extends between the step platform and the support wall, and further wherein the step platform, support wall and gusset are integrally formed together.

15. The storage rack post and step assembly of claim 11 wherein:
the first fastener comprises:
a bolt having a head and a threaded shank; and,
a T-nut having a flange and an internally threaded barrel;
wherein the bolt threaded shank is adapted to be threadingly received in the T-nut internally threaded barrel;
the support surface is located on a support wall defined between the support surface and a rear surface and the first bore extends through the support wall and the first boss from the support wall rear surface to a terminal end of the first boss;
the first fastener T-nut barrel is received in the first bore with its flange abutting the rear surface of the support wall; and,
the first fastener bolt extends through the storage rack post with its head abutting a rear surface of the storage rack post and its threaded shank threadingly received within the T-nut internally threaded barrel.

16. The storage rack post and step assembly of claim 15 wherein the fastener T-nut further comprises a plurality of prongs extending into the support wall.

17. The storage rack post and step assembly of claim 15 wherein the first fastener further comprises a lock washer.

18. The storage rack post and step assembly of claim 11 further comprising:
a second locating boss extending from the support surface configured to be received within a second storage rack post hole;
a second bore extending through the support surface and the second locating boss; and,
a second fastener configured to extend through the second storage rack post hole and the second bore, whereby both the first and second fasteners clampingly secure the storage rack post step to the storage rack post with the support surface abutting the storage rack post.

19. The storage rack post and step assembly of claim 18 wherein:
the first and second fasteners each comprise:
a bolt having a head and a threaded shank; and,
a T-nut having a flange and an internally threaded barrel;
wherein the bolt threaded shank is adapted to be threadingly received in the T-nut internally threaded barrel;
the support surface is located on a support wall defined between the support surface and a rear surface;
the first bore extends through the support wall and the first boss from the support wall rear surface to a terminal end of the first boss;
the first fastener T-nut barrel is received in the first bore with its flange abutting the rear surface of the support wall;
the first fastener bolt extends through the storage rack post with its head abutting a rear surface of the storage rack post and its threaded shank threadingly received within the first fastener T-nut internally threaded barrel;
the second bore extends through the support wall and the second boss from the support wall rear surface to a terminal end of the second boss; and,
the second fastener T-nut barrel is received in the second bore with its flange abutting the rear surface of the support wall;
the second fastener bolt extends through the storage rack post with its head abutting a rear surface of the storage rack post and its threaded shank threadingly received within the second fastener T-nut internally threaded barrel.

20. The storage rack post step of claim 19 wherein the first and second fastener T-nuts each further comprise a plurality of prongs extending into the support wall.
